(19) United States
(12) Patent Application Publication
(10) Pub. No.: US 2014/0260952 A1
(43) Pub. Date: Sep. 18, 2014

(54) ROTARY VANE ACTUATOR SEAL

(71) Applicant: Trelleborg Sealing Solutions US, Inc., Fort Wayne, IN (US)

(72) Inventors: Jennifer E. Alday, Fort Wayne, IN (US); John J. Mountz, Kendallville, IN (US); Larry J. Castleman, Monroeville, IN (US)

(73) Assignee: TRELLEBORG SEALING SOLUTIONS US, INC., Fort Wayne, IN (US)

(21) Appl. No.: 14/204,480

(22) Filed: Mar. 11, 2014

Related U.S. Application Data
(60) Provisional application No. 61/777,303, filed on Mar. 12, 2013.

(51) Int. Cl. B25J 9/10

(52) U.S. Cl. CPC B25J 9/10
USPC 92/124; 92/261

(57) ABSTRACT

A sealing system for use in a rotary vane actuator having a stator and a rotor coupled to the stator. The rotor or the stator has a vane. The rotor or the stator has a groove within which the seal is positioned. The stator, the rotor and the seal coact to define a chamber. The vane being movable thereby altering a volume of the chamber, with the seal being continuous.

### CROSS REFERENCE TO RELATED APPLICATIONS

This is a non-provisional application based upon U.S. provisional patent application Ser. No. 61/777,303, entitled “ROTARY VANE ACTUATOR SEAL”, filed Mar. 12, 2013, which is incorporated herein by reference.

### BACKGROUND OF THE INVENTION

1. Field of the Invention

The present invention relates to seals, and, more particularly, to a sealing system for a rotary vane actuator.

2. Description of the Related Art

Rotary vane actuators are used as an integral part of some robotic devices. For example, some robotic arms have multiple joints that utilize a ported rotary vane actuator. Each joint is connected to one or more ports and to a valve for moving each joint separately and/or conjunctively depending on the needed control.

In order for these robotic arms to function properly, the rotor is rotated by fluid under high pressure. The fluid may be under pressures of 3000 pounds per square inch (PSI). It is generally unacceptable for the pressurized fluid to leak. Any leakage of fluid in the actuator may cause the robotic device to move in error or not to the degree of repeatability that is desired. Gravitational forces acting upon the robotic arm may cause movement thereby, degrading the ability of the robotic device to remain stationary when hydraulic power is turned off.

Various attempts in the prior art have been directed at resolving the leakage issue in rotary vane actuator devices with limited success. For example, in U.S. Pat. No. 4,510,850, attempts are made to place a seal between the end walls of the vane and the actuator housing. However, in this attempted solution the vane seals are linear and the goal is to match the seal length with the seal between the vane seal and actuator housing.

In U.S. Pat. No. 4,565,119, there is disclosed a vane-type rotary actuator employing a disc like seal member made of an elastic material with a center opening. The vanes appear to use one or more elastomeric O-rings to establish a continuous contact with the cylinder. However, this disclosure does not address the potential leak path between the ports or the end plates.

Rotary vane actuators are very desirable since they may be designed to have only one moving part. This is accomplished by having the actuator shaft and vane as a single machined piece. The vane is designed to have a minimal clearance between the internal surfaces of the case-halves, and a seal is disposed on the peripheral surfaces of the vane to minimize leakage. The case-halves also include a port through which the shaft may extend. A seal may also be disposed between the shaft and the ports to minimize leakage of fluid.

One problem associated with prior art vane actuators is excess leakage of fluid from one side of the vane to the other, as well as leakage between the two seals on the vanes and the ends. This prevents the actuator from maintaining the precise control over the component to be actuated or positioned.

What is needed in the art is an actuator sealing system that can be easily produced using established manufacturing techniques and which provides the actuator with virtually no leak paths.

### SUMMARY OF THE INVENTION

The present invention provides a sealing system that uses a singular seal to seal an entire chamber of a rotary vane actuator.

The invention in one form is directed to a sealing system for use in a rotary vane actuator having a stator and a rotor coupled to the stator. The rotor or the stator has a vane. The rotor or the stator has a groove within which the seal is positioned. The stator, the rotor and the seal coact to define a chamber. The vane being movable thereby altering a volume of the chamber, with the seal being continuous.

The invention in another form is directed to a method of sealing a rotary vane actuator having a stator coupled with a rotor. The method includes the steps of positioning a seal and defining at least one chamber. The seal is positioned in a seal in a groove of the stator or the rotor. The chamber is defined by the coacting of the stator, the rotor and the seal. A vane extends from the rotor or the stator. The vane is movable thereby altering a volume of the chamber; and the seal is continuous.

An advantage of the present invention is that a one-piece seal seals an entire chamber of a rotary vane actuator, thereby reducing leak paths.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective partially sectioned view of a rotary vane actuator according to the present invention;

FIG. 2 is an exploded view illustrating the rotary vane actuator of FIG. 1;

FIG. 3 is a perspective view of another embodiment of a rotary vane actuator according to the present invention;

FIG. 4 is a perspective view of yet another embodiment of a rotary vane actuator according to the present invention;

FIG. 5 is a perspective view of still yet another embodiment of a rotary vane actuator according to the present invention;

FIG. 6 is a perspective view of still yet another embodiment of a rotary vane actuator according to the present invention; and

FIG. 7 is a perspective view of a seal used in the rotary vane actuators of FIGS. 4-6.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

Referring now to the drawings, and more particularly to FIGS. 1 and 2, there is shown a rotary vane actuator 10 according to the present invention. The rotary vane actuator 10 includes a stator 12 and a rotor 14. Rotor 14 is situated within stator 12 such that rotational movement between stator 12 and rotor 14 takes place when pressurized fluid is introduced therebetween. Continuous stator grooves 16, and 18 exist in respective portions of stator 12 for the disposition of continuous seals 30 and 32. Ports for the controlled application and removal of fluid are not shown, for purposes of clarity. A vane 20 is an elevated portion of rotor 14. Chambers 22 and 24 are formed, with vane 20 extending into each of chambers 22 and 24. The rotational movement of vane 20 is caused by the introduction and/or removal of fluid under pressure from chambers 22 and 24, by action of valves, not shown. Likewise the rotation of vane 20 can also cause fluid to be removed or drawn into a particular chamber, by action of valves, not shown.

Rotor plates 26 and 28 are directly connected to rotor 14, allowing stator grooves 16 and 18, along with seals 30 and 32 to completely, respectively, seal chambers 22 and 24. The serpentinely continuous stator grooves 16 and 18 accommodate the serpentine continuous seals 30 and 32 to seal chambers 22 and 24 from each other as well as the exterior of rotary vane actuator 10. A single seal accomplishes the sealing of each chamber. Stator grooves 16 and 18, and hence seals 30 and 32 include several 90° or approximately 90° bends, with four being seen in each groove 16 and 18 in FIG. 1, and it can be visualized that the opposite side has an additional four bends. The bends in the seal are the reason the word “serpentinely” is used to describe the seals and the grooves. Seals 30 and 32 are identical, just having different orientations. The use of the word “continuous” relative to the grooves and seals is meant to mean without having an end.

Complementary portions of rotor 14, stator 12, vane 20, and seals 30 and 32 coact to create chambers 22, and 24. Rotor plates 26 and 28 are shown without additional features, but they can be understood to represent connecting features and or extending features such as portions of robotic manipulating devices.

Now, additionally referring to FIG. 3, there is illustrated another embodiment of the present invention, with similar items now having 100 added to the reference number of those previously identified. Here rotor 114 has a vane 120 and a vane 120′. The rotor plates and seals are omitted in subsequent illustrations for the ease of illustrating the groove (and hence seal) geometry and interaction of the seals, but the presence of the rotor plates and seals can be assumed. There is a rotor groove 140 in which a seal similar in composition as seals 30 and 32, but shaped to follow rotor groove 140. Here stator groove 116 accommodates a seal that respectively seals chambers 122 and 122′, with part of the seal that sets in rotor groove 140 functioning to divide chamber 122 from chamber 122′. In a like manner stator groove 118 accommodates a seal that respectively seals chambers 124 and 124′, with part of the seal that sets in rotor groove 140 functioning to divide chamber 124 from chamber 124′. This construct has the seal that sits in stator groove 116 touching the seal that sits in rotor groove 140 at four points, two of which are seen in the figure, with the symmetry of the construct indicating that the other two are a mirror image on the side opposite to that shown. The word “point” is used to describe the small contact area where the seals interact. The corresponding elements also exist relative to chambers 124 and 124′. The side of stator grooves 116 and 118 that is closest to chambers 122, 122′, 124 and 124′ may have a reduced height to enable a part of the stator seals that sit in stator grooves 116 and 118 to extend toward the respective chambers and to allow the rotor seal to contact the stator seal. A similar accommodation may exist in other embodiments of the present invention.

Now, additionally referring to FIG. 4 there is illustrated another embodiment of the present invention, with similar items now having a multiple of 100 added to the reference number of those previously identified. Here a single stator groove 216 accommodates a single stator seal that seals chambers 222 and 224 with a vane 220 having a rotor groove 240 that accommodates a seal, which touches and interacts with the seal in stator groove 216 at two points. The seal of vane 220 can be a continuous seal that is captivated between two arms of vane 220, with the seal being compressed against a surface of stator 212, a surface of rotor 214 and the two rotor plates that are not shown for the ease of illustration, but are collectively shown in FIGS. 6 and 7. In FIG. 6, eight seal retainers 50 are illustrated, which each used a seal 52 of FIG. 7. Here in FIG. 4 one seal retainer 50 and a seal 52 that sets in the groove of retainer 50, is placed between the arms of vane 220.

Now, additionally referring to FIG. 5 there is illustrated another embodiment of the present invention, with similar items now having a multiple of 100 added to the reference number of those previously identified. Here the stator groove is not shown, but a seal of circular configuration on the face of the stator would be present. Here vanes 320 and 320′ on rotor 314 serve to define chambers 322, 322′, 324 and 324′, along with stator vanes 342 and 342′, which are mirror images of rotor vanes 320 and 320′. This embodiment may employ four seals of common and even identical configuration positioned between the arms of vanes 320, 320′, 342 and 342′, such as the combination of seal retainer 50 and seal 52, discussed above. Seal retainer 50 may have a solid core with a groove that accommodates continuous seal 52 that runs along the periphery of the solid core.

Now, additionally referring to FIG. 6 there is illustrated another embodiment of the present invention, with similar items now having a multiple of 100 added to the reference number of those previously identified. Here again the stator groove is not shown, but a seal of circular configuration on the face of the stator would be present. Here vanes 420 and 420′ on rotor 414 serve to define chambers 422, 422′, 424 and 424′, along with stator vanes 442 and 442′, which are mirror images of rotor vanes 420 and 420′. This embodiment may employ 8 seals of common and even identical configuration with two being connected to opposite sides of each of vane 420, 420′, 442 and 442′, such as the combination of seal retainer 50 and seal 52 discussed above. Seal retainers 50 are connected to vanes 420, 420′, 442 and 442′ in a conventional manner.

Seals 30, 32 and 52 may have a wear-resistant portion coupled to a resilient portion. The descriptions of wear-resistant and resilient are meant to portray relative prominent characteristics and not exclusive characteristics, in that, for example, the wear resistant portion will have a resilient characteristic, but perhaps not to the degree of the resilient portion. The portions are bonded together to produce seal 30, 32 or 52. The wear-resistant portion may be made of a polymer material and the resilient portion may be made of an elastomer, although other materials are also contemplated. Seals 30, 32, 52 may be unidirectional or bidirectional. The terms unidirectional and bidirectional refer to pressurized sides of the application and not to a particular direction in which the seal moves relative to the assembly.

Advantageously, seal 30, 32 and 52 are each a serpentine continuous seal. In the prior art a typical actuator will have an inner corner seal and an outer corner seal on each end of the rotor/stator assembly, and a seal for each vane. So if a configuration of an actuator as shown in FIG. 1 were to use the prior art technique, there would be two inner corner seals, two outer corner seals, two seals for the stator and a seal for the vane of the rotor, for a total of seven seals. This configuration could disadvantageously have some portion of each seal in contact with other seals resulting in potential unacceptable leakage. In contrast, the present invention has two identical seals (for this configuration) resulting in fewer seals and types of seals needed to produce actuator 10.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sealing system for use in a rotary vane actuator having a stator and a rotor coupled to the stator, the sealing system comprising:
a seal, one of the rotor and the stator having a vane, one of the rotor and the stator having a groove within which said seal is positioned, the stator, the rotor and said seal coacting to define a chamber, said vane being movable thereby altering a volume of said chamber, said seal being continuous.

2. The sealing system of claim 1, wherein said groove is serpentinely continuous, said seal also being serpentinely continuous.

3. The sealing system of claim 2, further comprising an other seal, one of the rotor and the stator having an other groove within which said other seal is positioned, the rotor, the stator, and said other seal coacting to define an other chamber.

4. The sealing system of claim 3, wherein said seal and said other seal are interchangeable.

5. The sealing system of claim 1, further comprising a first stator seal and a second stator seal, said groove being associated with the rotor, said seal being a rotor seal, the stator having a first groove and a second groove, said first groove and said second groove being substantially a mirror image of said first groove, said first stator seal being positioned in said first stator groove, said second stator seal being positioned in said second stator groove.

6. The sealing system of claim 5, wherein said first stator seal is in contact with said rotor seal at four points.

7. The sealing system of claim 6, wherein said second stator seal is in contact with said rotor seal at four points.

8. The sealing system of claim 5, wherein, said vane is associated with the rotor, the rotor additionally having an other vane, said rotor seal extending along a surface of both said vane and said other vane.

9. The sealing system of claim 1, wherein said groove is a stator groove, said seal being a stator seal, said vane having a vane seal, said stator seal sealing chambers on each side of said vane.

10. The sealing system of claim 9, wherein said vane seal is in contact with said stator seal at two points.

11. A method of sealing a rotary vane actuator having a stator coupled with a rotor, the method comprising the steps of:
positioning a seal in a groove of one of the stator and the rotor; and
defining a chamber by the coacting of the stator, the rotor and said seal, a vane extending from one of said rotor and said stator, said vane being movable thereby altering a volume of said chamber, said seal being continuous.

12. The method of claim 11, wherein said groove is serpentinely continuous, said seal also being serpentinely continuous.

13. The method of claim 12, further comprising the step of positioning an other seal in an other groove of one of the rotor and the stator, the rotor, the stator, and said other seal coacting to define an other chamber.

14. The method of claim 13, wherein said seal and said other seal are interchangeable.

15. The method of claim 11, further comprising a first stator seal and a second stator seal, said groove being associated with the rotor, said seal being a rotor seal, the stator having a first groove and a second groove, said first groove and said second groove being substantially a mirror image of said first groove, said first stator seal being positioned in said first stator groove, said second stator seal being positioned in said second stator groove.

16. The method of claim 15, wherein said first stator seal is in contact with said rotor seal at four points.

17. The method of claim 16, wherein said second stator seal is in contact with said rotor seal at four points.

18. The method of claim 15, wherein, said vane is associated with the rotor, the rotor additionally having an other vane, said rotor seal extending along a surface of both said vane and said other vane.

19. The method of claim 11, wherein said groove is a stator groove, said seal being a stator seal, said vane having a vane seal, said stator seal sealing chambers on each side of said vane.

20. The method of claim 19, wherein said vane seal is in contact with said stator seal at two points.
